(19) United States
(12) Patent Application Publication
(10) Pub. No.: US 2024/0117831 A1
(43) Pub. Date: Apr. 11, 2024

(54) POST COUPLER

(71) Applicant: Jaken Co., Inc., Tustin, CA (US)

(72) Inventors: Christopher H. Berry, Coto de Caza, CA (US); Dan Ta-Yuan Wu, Daimond Bar, CA (US)

(21) Appl. No.: 17/961,498

(22) Filed: Oct. 6, 2022

(51) Int. Cl. A47B 47/02; A47B 47/00

(52) U.S. Cl. CPC A47B 47/021; A47B 47/0033; A47B 2220/0036

(57) ABSTRACT

A post coupler having a top end portion and bottom end portion, a first body portion and a second body portion. Each body portion having an inner edge, an outer edge, a reverse flange, and a post stop. Each reverse flange forms a post receiving slot, and each post stop extends towards its respective body portion. The first and second body portions are coupled to each other at approximately 90 degrees. A method of using the post coupler comprises the steps of a) providing a first post section and a second post section, b) inserting the first post section along the post receiving slots until the first post section abuts one side of the post stops, and c) inserting the second post section along the post receiving slots until the second post section abuts an other side of the post stops.

### BACKGROUND

Storage racks and shelving that be assembled and dissembled by a user have become popular. However, there are notable limitations with respect to known storage racks, including a large number of parts and being difficult to assemble. In particular, the post couplers used to connect one or more support posts together can be cumbersome to use, or use a large amount of material, making them expensive to manufacture.

Accordingly, there is a need for an improved post coupler.

### SUMMARY

In a first embodiment, the invention described herein is directed to a post coupler comprising a first body portion and a second body portion.

The first body portion has a first reverse flange coupled to the first body portion, and the first reverse flange forms a first post receiving slot. There is a first post stop coupled to the first reverse flange that extends towards the first body portion.

The second body portion has a second reverse flange coupled to the second body portion, and the second reverse flange forms a second post receiving slot. There is a second post stop coupled to the second reverse flange that extends towards the second body portion.

The first and second body portions are coupled to each other along one side.

The post coupler can have a top end portion and a bottom end portion, wherein the top end portion and the bottom end portion are opposed to each other.

Optionally, the first body portion has a first inner edge and a first outer edge, and the second body portion has a second inner edge and a second outer edge, and the second inner edge is coupled to the first inner edge of the first body portion at approximately 90 degrees to the first body portion.

In a second embodiment, the present invention is directed to a method of using the post coupler. The method comprises the steps of:
a) providing a first post section and a second post section;
b) inserting the first post section into one end portion of the post coupler along the first and second post receiving slots until the first post section abuts one side of the first and second post stops; and
c) inserting the second post section into the opposed end portion of the post coupler, along the first and second post receiving slots until the second post section abuts an other side of the first and second post stops.

### BRIEF DESCRIPTION OF DRAWINGS

These and other features, aspects, and advantages of the present invention will become better understood with regard to the following description, appended claims, and accompanying drawings.

FIG. 1 a perspective view of a post coupler having features of the present invention;

FIG. 2 is a top plan view of the post coupler of FIG. 1;

FIG. 3 is a perspective view of a plurality of post couplers of FIG. 1 installed to form a shelving system;

FIGS. 4 and 5 are enlarged, detailed views of steps involved in coupling two posts together using the post coupler of FIG. 1;

FIG. 6 is a sectional view of a post coupler of FIG. 1, wherein a bottom post has been inserted into one end of the post coupler and is in contact with two post stops of the post coupler, and a top post is being slide into an other end of the post coupler;

FIG. 7 is an enlarged, detailed view of a portion of the post coupler and top post of FIG. 6, taken along line 7-7;

FIG. 8 is a sectional view of the post coupler and top post of FIG. 6, taken along line 8-8; and

FIG. 9 is an enlarged, sectional view of a portion of the post coupler and top post of FIG. 8, taken along line 9-9.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and using the invention in connection with the illustrated embodiments. It is to be understood, however, that the same or equivalent functions and sequences may be accomplished by different embodiments that are also intended to be encompassed within the spirit and scope of the invention.

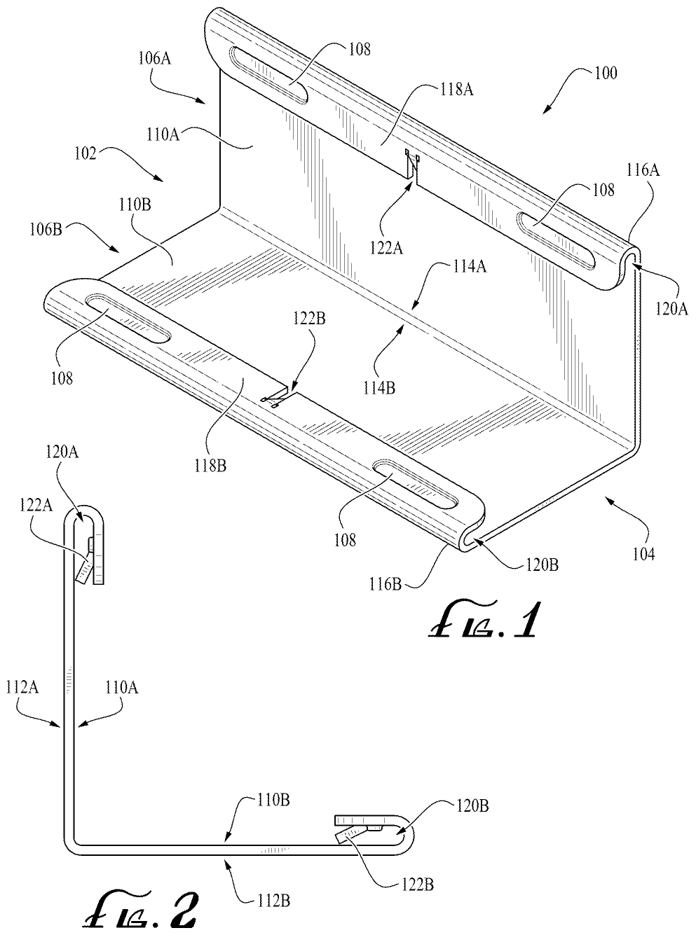

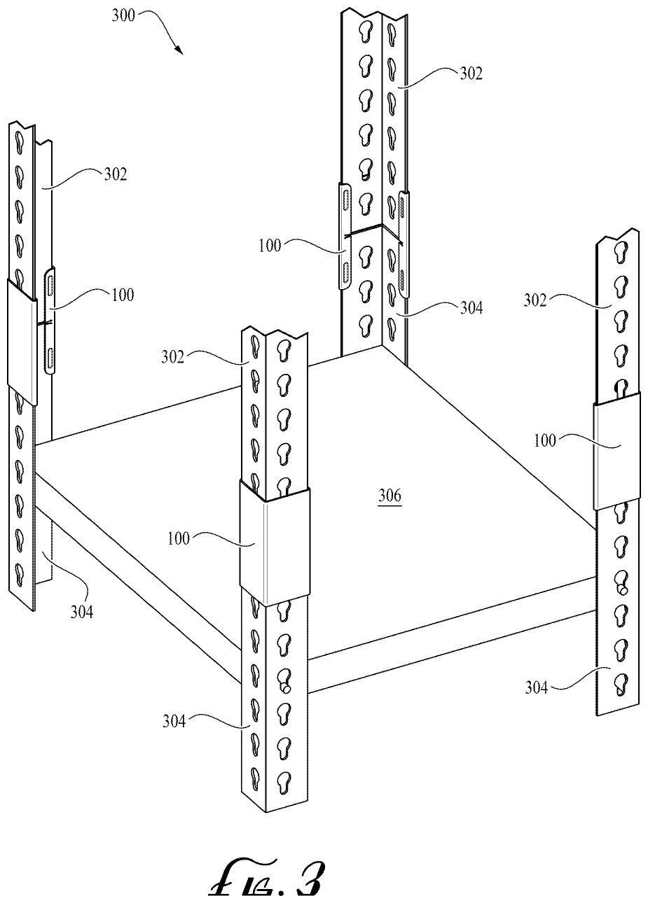

Referring now to FIGS. 1 and 2, there is shown a post coupler 100 having features of the present invention. The post coupler 100 has a top end portion 102, an opposed bottom end portion 104, a first body portion 106A and a second body portion 106B. The use of the terms “top” and “bottom” are not limiting and are used simply for ease of reference when the post coupler 100 is being used to form a single post.

Each body portion has an inside surface 110A 110B, an outside surface 112A, 112B, an inner edge 114A, 114B, an outer edge 116A, 116B, a reverse flange 118A, 118B and a post stop 122A, 122B coupled to the respective reverse flange 118A, 118B.

The first body portion 106A is coupled to the second body portion 106B along their respective inner edges 114A, 114B. Preferably, the first body portion 106A and the second body portion 106B are at an approximate right angle, or 90 degrees, from each other. Optionally, the body portions 106A, 106B can be at any angle with respect to each other in order to accommodate different shaped post portions 302, 304.

Each reverse flange 118A 118B is coupled to the outer edge 116A, 116B of its respective body portion 106A, 106B, thereby forming two post receiving slots 120A, 120B that extend the length of each reverse flange 118A, 118B. Positioned along each post receiving slot 120A, 120B is a post stop 122A, 122B. The post stops 122A, 122B extend from their respective reverse flanges 118A, 118B towards the inside surfaces 110A, 110B of their respective body portions 106A, 106B, forming a physical stop against which two post portions will abut, one on each side of the post stop 122A, 122B.

Optionally, each reverse flange 118A, 118B comprises at least one protrusion 108 that applies pressure to a post section 302, 304 inserted along the slots 120A, 120B. Preferably, there are two protrusions on each reverse flange 118A, 118B to apply pressure to both post sections 302, 304 inserted therein. The protrusions 108 are formed by pushing a portion of the reverse flange 118 inward, towards the body portion 106, thereby forming a recess on an outer surface of the reverse flange 118, and a protrusion 108 on an inside surface of the reverse flange 118.

Referring now to FIGS. 3 through 9, the function of the post stops 122A, 122B can be seen. As noted above, the post stops 122A, 122B form a physical stop that two post portions 302, 304 abut, allowing the two post portions 302, 304 to form/function as a single post. Each post stop 122A, 122B is formed by cutting a portion of the reverse flange 118A, 118B and bending it inwards, towards the inside surface of the 110A, 110B of the body portion 106A, 106B. As such, the post stops 122A, 122B are integral with the coupler 100.

Optionally, the post stops 122A, 122B are extensions that are welded on to, or coupled to the reverse flanges 118A, 118E as opposed to being integral pieces of the reverse flanges 118A, 118B.

Optionally, the coupler 100 only comprises one post stop 122A on one reverse flange 118A.

FIG. 3 shows a typical rack/shelving system 300, wherein four post couplers 100 and eight post portions 302, 304 are utilized to support at least one shelf 306.

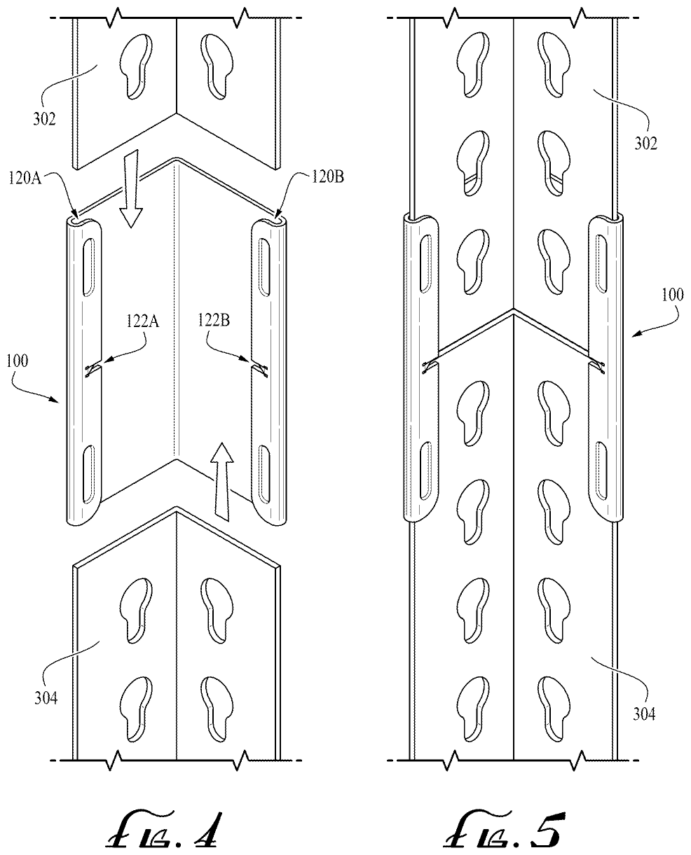

FIGS. 4 and 5 show the progression of inserting two post portions 302, 304 into their respective post receiving slots 120A, 120B. One post section 302, 304 is inserted along each end portion 102, 104 of the coupler 100, and the edges of the post sections 302, 304 slide down the slots 120A, 120B until they abut the stops 122A, 122B.

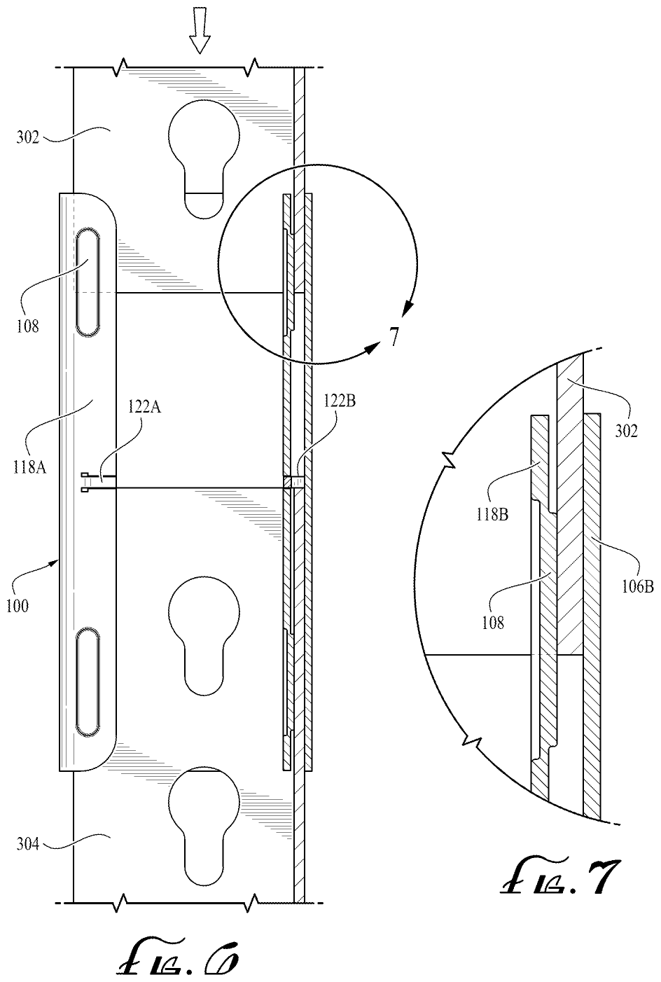

FIGS. 6 and 7 show detailed, sectional views of the post portion 302, 304 insertion into a coupler 100. The protrusions 108 apply pressure against the post section 302, performing a gripping function. This application of pressure/gripping can be seen in FIG. 7.

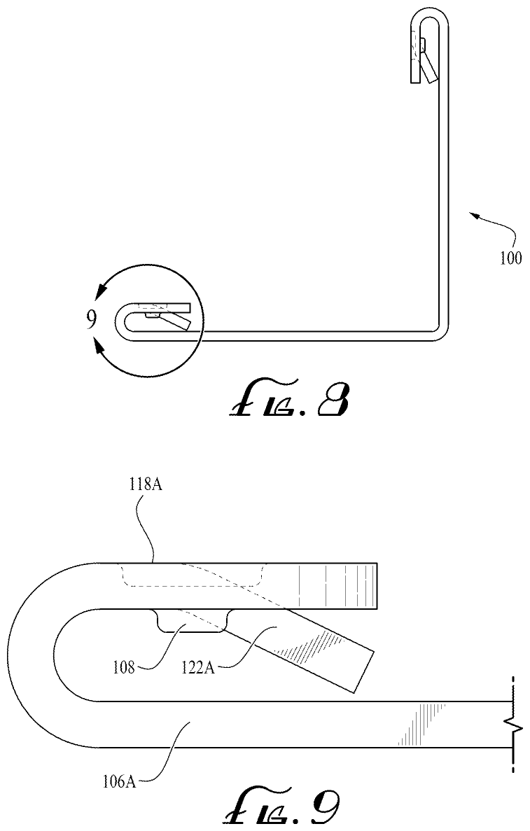

FIGS. 8 and 9 provide additional, detailed views of the post stops 122A, 122B, wherein the orientation of the protrusions 108 with respect to the post stops 122A, 122B can be seen.

The post coupler 100 can be made from any material including but not limited to metal, plastic or a composite material such as carbon fiber. Optionally, the post coupler 100 is made from steel.

While not necessary, preferably, the coupler 100 is formed from a single piece of material that has its sides bent to form the reverse flanges 118, with the post stops 122 cut therefrom, and is then bent in half again, at an angle, to form the body portions 106. Optionally, each component of the coupler 100 is formed from a separate piece of material that is then coupled together by welding or some other form of physical coupling.

A method of using the post coupler 100 comprises the steps of:
a) providing a first post section 302 and a second post section 304;
b) inserting the first post section 302 into one end portion of the post coupler 100 along the first and second post receiving slots 120A, 120B until the first post section 302 abuts one side of the first and second post stops 122A, 122B; and
c) inserting the second post section 304 into the opposed end portion of the post coupler 100, along the first and second post receiving slots 120A, 120B until the second post section 304 abuts an other side of the first and second post stops 122A, 122B.

Optionally, the second post section 304 is inserted into the post coupler 100 first, and then the first post section 302 is inserted into the post coupler 100, and as such, the use of the terms “first post section” and “second post section” are not limiting to their specific order of insertion.

The post coupler 100 of the present invention has the advantage that no extra material is required to form the post stops 122A, 122B. Instead, a portion of each reverse flange 118A, 188B is cut and bent inwards, towards the interior surface of its respective body portion 106A, 106B, thereby forming a physical post stop. As such, the post coupler 100 utilizes less material than the post couplers of the prior art, making it cheaper to manufacture,

The foregoing description of the preferred embodiment(s) of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A post coupler comprising a top end portion and bottom end portion:
a) a top end portion;
b) an bottom end portion opposed the top end portion;
c) a first body portion having:
i) a first inner edge;
ii) a first outer edge;
iii) a first reverse flange coupled to the first outer edge, forming a first post receiving slot; and
iv) a first post stop coupled to the first reverse flange, wherein the first post stop extends towards the first body portion; and
d) a second body portion having:
i) a second inner edge coupled to the first inner edge of the first body portion;
ii) a second outer edge;
iii) a second reverse flange coupled to the second outer edge, forming a second post receiving slot; and
iv) a second post stop coupled to the second reverse flange, wherein the second post stop extends towards the second body portion:
wherein the first and second body portions are coupled to each other at approximately 90 degrees.

2. A post coupler comprising a top end portion and bottom end portion:
a) a first body portion having:
i) a first reverse flange coupled to the first body portion forming a first post receiving slot; and
ii) a first post stop coupled to the first reverse flange, wherein the first post stop extends towards the first body portion; and
b) a second body portion having:
i) a second reverse flange coupled to the second body portion forming a second post receiving slot; and
ii) a second post stop coupled to the second reverse flange, wherein the second post stop extends towards the second body portion;
wherein the first and second body portions are coupled to each other along one side.

3. The post coupler of claim 2, further comprising a top end portion and a bottom end portion, wherein the top end portion and the bottom end portion are opposed to each other.

4. The post coupler of claim 2, wherein the first body portion further comprises a first inner edge and a first outer edge.

5. The post coupler of claim 4, wherein the second body portion further comprises a second inner edge and a second outer edge, wherein the second inner edge is coupled to the first inner edge of the first body portion at approximately 90 degrees to the first body portion.

6. A method of using the post coupler of claim 1, the method comprising the steps of:
a) providing a first post section and a second post section;
b) inserting the first post section into one end portion of the post coupler along the first and second post receiving slots until the first post section abuts one side of the first and second post stops; and
c) inserting the second post section into the opposed end portion of the post coupler, along the first and second post receiving slots until the second post section abuts an other side of the first and second post stops.

7. A method of using the post coupler of claim 2, the method comprising the steps of:
a) providing a first post section and a second post section;
b) inserting the first post section along the first and second post receiving slots until the first post section abuts one side of the first and second post stops; and
c) inserting the second post section along the first and second post receiving slots until the second post section abuts an other side of the first and second post stops.
